(19) United States
(12) Patent Application Publication
(10) Pub. No.: US 2008/0088273 A1
(43) Pub. Date: Apr. 17, 2008

(54) FUEL CELL DEVICE WITH RESERVED SIGNAL PINS

(76) Inventors: Hsi-Ming Shu, Taipei (TW); Tsang-Ming Chang, Taipei (TW); Chien-An Chen, Taipei (TW); Wen Jui Chuang, Taipei (TW)

Correspondence Address: G. LINK CO., LTD., 3550 BELL ROAD, MINOOKA, IL, 60447, US

(21) Appl. No.: 11/872,013

(22) Filed: Oct. 14, 2007

(30) Foreign Application Priority Data
Oct. 16, 2006 (TW) 095138000

(51) Int. Cl. H02J 7/00; H01M 8/04

(52) U.S. Cl. 320/101; 429/24

(57) ABSTRACT

The present invention discloses a fuel cell device with reserved signal pins, which comprises a fuel cell pallet, a first fan, a condenser, an anode fuel storage tank, a buffer container, a dosing pump, a circulation pump, and the above-said devices are respectively configured with a temperature sensor, a liquid level sensor, a density sensor, a rotational speed sensor. Thus, the energy management system could not only control based on the status signal of the fuel cell pallet, but also further control with the temperature, liquid level, density, rotational speed, and the like data provided by these sensors.

### FIELD OF THE INVENTION

The present invention relates to a fuel cell, and particularly to a fuel cell device with reserved signal pins.

### BACKGROUND OF THE INVENTION

Fuel cell (FC) is a kind of power generation device by directly converting chemical energy into electrical energy. Comparing with the conventional power generation method, the fuel cell provides the advantages, such as low pollution, low noise, high energy density, higher energy conversion rate, and becomes an electric source with highly potential. With these advantages, the fuel cell could have a very wide application range, which covers the portable electronic device, household power generation, the traffic vehicles, and aerospace industry.

The working temperature of the direct methanol fuel cell (DMFC) could be from the room temperature to about 130° C., and the basic operation principle is that the electrodes play as the location for electron transition; introducing the methanol aqueous solution onto the anode surface for electrically catalyzed oxidation reaction for the fuel, such as hydrogen, to generate CO₂ and H⁺ and release the electrons, and the electrons would be conducted to the cathode through the external circuit for the reduction with the oxidant, such as oxygen, and generating water (H₂O in chemical formula); the fuel, such as hydrogen, and the oxidant, such as oxygen, entering the fuel cell should both employ the catalysis with catalyst to increase the reaction rate.

However, generally speaking, the information, such as rotational speed, liquid level and fuel density, of each device in DMFC, such as fan, pump and mixing tank, could not be individually controlled, so that the experiment or control of DMFC could hardly be completed.

### SUMMARY OF THE INVENTION

The object of the present invention is to provide a fuel cell device with reserved signal pins, and the belonged energy management system could not only control based on the status signal of the fuel cell pallet, but also install in advance with various sensors in the relative devices and employ the information, such as temperature, liquid level, density and rotational speed, provided by these sensors for further control.

To this end, the fuel cell device with reserved signal pins according to the present invention mainly comprises a fuel cell pallet, a first fan, a condenser, an anode fuel storage tank, a buffer container, a dosing pump, a circulation pump, and the above-said devices are respectively configured with temperature sensor, liquid level sensor, density sensor, and rotational speed sensor, and the like.

The fuel cell pallet at least comprises an anode catalyst electrode, a cathode catalyst electrode, and a proton exchange membrane configured between the anode catalyst electrode and the cathode catalyst electrode, and introducing the anode fuel and the cathode fuel to the anode catalyst electrode and the cathode catalyst electrode through the channel.

### BRIEF DESCRIPTION OF DRAWINGS

The advantages and spirit relating to the present invention could be further understood with the following detailed description of the present invention and the attached figures, wherein:

FIG. 1 is a diagram of the fuel cell device with reserved signal pins according to the present invention.

### DETAILED DESCRIPTION OF THE INVENTION

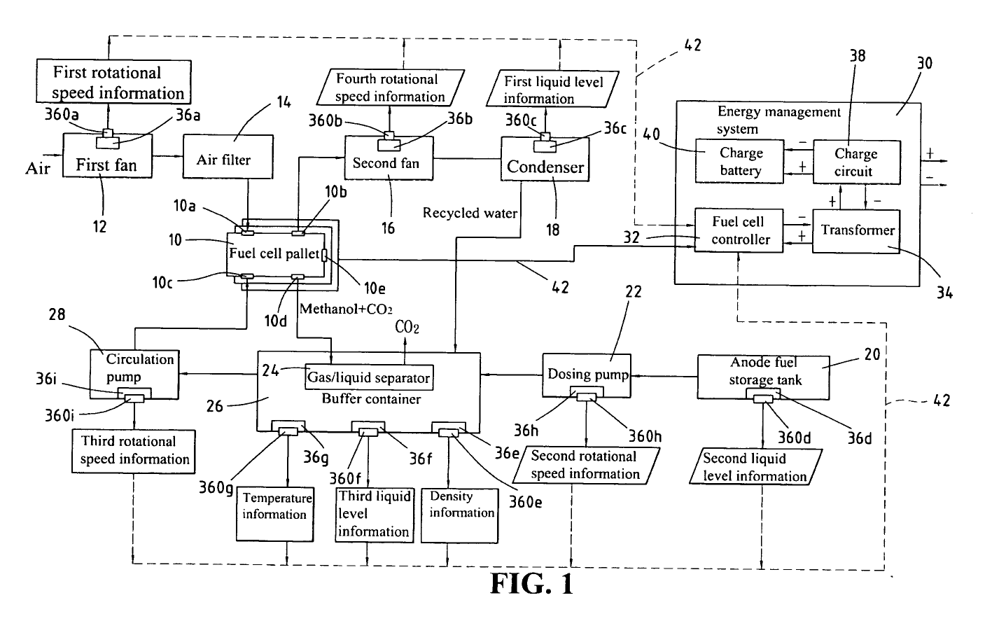

As shown in FIG. 1, the fuel cell device with reserved signal pins according to the present invention mainly comprises: a plurality of fuel cell pallets 10, a first fan 12, a condenser 18, an anode fuel storage tank 20, a buffer container 26, a dosing pump 22, a circulation pump 28, and an energy management system 30. The fuel cell pallet 10 at least comprises an anode catalyst electrode, a cathode catalyst electrode, and a proton exchange membrane configured between the anode catalyst electrode and the cathode catalyst electrode. The anode fuel, such as methanol solution, is introduced through the anode fuel inlet 10c, and flowing to the anode catalyst electrode, and finally flowing out from the anode fuel outlet 10d. The cathode fuel, such as air, is introduced through the cathode fuel inlet 10a, and flowing to the cathode catalyst electrode, and finally flowing out from the anode fuel outlet 10b. Because the anode catalyst electrode, the cathode catalyst electrode and the proton exchange membrane are all well-known components, they are omitted and not shown on the figure.

The fuel cell device with reserved signal pins according to the present invention receives these status signals from the fuel cell pallets 10, and controls the dosing pump 22 and the circulation pump 28 based on the status signals, so that the density, volume and temperature of the anode fuel introduced to the fuel cell pallets 10 could be matched with the configuration conditions; and, controlling the first fan 12 according to the status signals, so that the flow volume of the air introduced to the fuel cell pallets 10 could be matched with the configuration conditions. The at least one status signal generated in the operation of the fuel cell pallets 10 would be transmitted to the fuel cell controller 32 through the connection interface 10e and the communication link 42, such as cable.

The fuel cell device with reserved signal pins according to the present invention would again employ the recycled water and the un-reacted methanol fuel, and suitable mix them after recycling to again become the anode fuel. In the recycle process, the condenser 18 would collect the vapor released by the fuel cell pallets 10 through the cathode fuel outlet 10b, and condense into the recycle water, then introduce to the buffer container 26. The gas/liquid separator 24 in the buffer container 26 is connected to the anode fuel outlet 10d, and separates the carbon dioxide (CO₂) from the anode fuel outlet 10d and the un-reacted methanol anode fuel, but only keeps the methanol, and exhausts the carbon dioxide. Therefore, the anode fuel mixed and stored in the buffer container 26 comes from the gas/liquid separator 24, the recycle water of the condenser (also including the external water source), and the anode fuel storage tank 20, respectively.

In order to supply the anode fuel to the fuel cell pallets 10, under the control of the controller 32, the dosing pump 22 would pump the anode fuel stored in the anode fuel storage tank 20 into the buffer container 26, and the circulation pump 28 would pump the mixed anode fuel stored in the buffer container 26 into the fuel cell pallets 10 through the anode fuel inlet 10c.

In order to further control all the parameters of the entire system, the fuel cell device with reserved signal pins according to the present invention particularly is configured various sensors in the above-said devices, and employs the information, such as temperature, liquid level, density and rotational speed, for further control.

Specifically, the first fan 12 would be under the detection of the first rotational speed sensor 26 to introduce air into the fuel cell pallets 10 through the cathode fuel inlet 10a. In order for the operator to further control all the parameters in the entire system, the first rotational speed sensor 36a employs the first rotational speed information of the first fan 12 provided through the first rotational speed pin 360a, and the first rotational speed pin 360a includes “+” power terminal, “−” power terminal, and “FG” rotational speed terminal.

The condenser 18 is provided with a first liquid level sensor 36c for detecting the first liquid level information of recycle water, and provides the first liquid level information through the first liquid level pin 360c. The anode fuel storage tank 20 is provided with a second liquid level sensor 36d for detecting the second liquid level information of the anode fuel, and provides the second liquid level information through the second liquid level pin 360d. The buffer container 26 is provided with a temperature sensor 36g, a third liquid level sensor 36f, and a density sensor 36e, wherein the temperature sensor 36g provides the temperature information of the mixed anode fuel through the temperature pin 360g; the third liquid level sensor 36f provides the third liquid level information of the mixed anode fuel through the third liquid level pin 360f, and, the density sensor 36e provides the density information of the mixed anode fuel through the density pin 360e.

The dosing pump 22 is provided with a second rotational speed sensor 36h for detecting the second rotational speed information, and provides the second rotational speed information through the second rotational speed pin 360h. The circulation pump is provided with a third rotational speed sensor 36i for detecting the third rotational speed information, and provides the third rotational speed information through the third rotational speed pin 360i.

Moreover, in order to collect the vapor released by the fuel cell pallets 10, a second fan 16 is additionally configured between the condenser 18 and the cathode fuel outlet 10b. The second fan 16 is also provided with a fourth rotational speed sensor 36b for detecting the fourth rotational speed information, and provides the fourth rotational speed information through the fourth rotational speed pin 360b.

The information to be transmitted through the pins 360a to 360i could be transmitted to the fuel cell controller 32 through the communication link 44, such as cable.

In order to keep the cleanness of the introduced air, an air filter 14 is additionally configured between the first fan 12 and the cathode fuel inlet 10 for filtering the air introduced through the first fan 12.

In order to provide the power required in the initialization stage of the fuel cell device, the energy management system 30 is additionally provided with a charge battery 40, and provides the required power through the charge battery 40. The charge circuit 38 would charge the charge battery 40 based on the power supplied by the transformer 34. After completion of the initialization stage of the fuel cell device, it would be changed to provide the required power from the fuel cell pallets 10. The transformer 34 is mainly used to regulate the voltage outputted by the fuel cell pallets 10 to a fixed voltage value.

The features and spirit of the present invention has been clearly described in details with the preferred embodiments as above, and these disclosed embodiments are not used to limit the scope of the present invention; in the opposite, the object is to cover all the various modification and equivalent arrangement within the scope of claims in the present invention.

What is claimed is:

1. A fuel cell device with reserved signal pins, the fuel cell device comprises:
at least one piece of fuel cell pallet, and the fuel cell pallet at least includes an electrical connection interface, and the electrical connection interface is used to provide the communication path for at least one status signal generated in the operation of the fuel cell pallets, and the fuel cell pallets all comprise an anode fuel inlet, an anode fuel outlet, a cathode fuel inlet, and a cathode fuel outlet;
a first fan, which introduces air to the fuel cell pallets through the cathode fuel inlet under the detection of a first rotational speed sensor, and the first rotational speed sensor provides a first rotational speed information of the first fan through a first rotational speed pin;
a condenser, which collects the vapor released by the fuel cell pallets through the cathode fuel outlet, and condenses into recycle water, and is provided with a first liquid level sensor for detecting the first liquid level information of the recycle water, and provides the first liquid level information through a first liquid level in;
an anode fuel storage tank, which stores the anode fuel, and is provided with a second liquid level sensor for detecting the second liquid level information of the anode fuel, and provides the second liquid level information through a second liquid level pin;
a buffer container, which at least includes a gas/liquid separator, a temperature sensor, a third liquid level sensor, a density sensor, in which the gas/liquid separator is connected to the anode fuel outlet, and separates the carbon dioxide and the un-reacted anode fuel from the anode fuel outlet, and the mixed anode fuel stored in the buffer container comes from the gas/liquid separator, the recycle water of the condenser, the anode fuel storage tank, and the temperature sensor employs a temperature pin to provide the temperature information of the mixed anode fuel, and the third liquid level sensor employs a third liquid level pin to provide the third liquid level information of the mixed anode fuel, and the density sensor employs a density pin to provide the density information of the mixed anode fuel;
a dosing pump, which is used to pump the anode fuel stored in the anode fuel storage tank into the buffer container, and is provided with a second rotational speed sensor for detecting a second rotational speed information, and provides the second rotational speed pin through a second rotational speed pin;
a circulation pump, which is used to pump the mixed anode fuel stored in the buffer container into the fuel cell pallets through the anode fuel inlet, and is provided with a third rotational speed sensor for detecting a third rotational information, and provides the third rotational speed information through a third rotational speed pin;
an energy management system, which at least comprises a fuel cell controller and a transformer, in which the fuel cell controller is used to receive the status signals from the fuel cell pallets, and control the dosing pump and the circulation pump based on the status signals, so that the density, flow volume and temperature of the anode fuel introduced to the fuel cell pallets could be matched with the configuration conditions, and control the first fan according to the status signals so that the flow volume of air introduced to the fuel cell pallets could be matched with the configuration conditions, and the transformer is used to regulate the voltage outputted by the fuel cell pallets to a fixed voltage value.

2. The fuel cell device with reserved signal pins according to claim 1, wherein the fuel cell device further comprises:
a second fan, which is configured between the condenser and the cathode fuel outlet, and used to intensively collect the vapor released by the fuel cell pallets and introduce into the condenser, and is provided with a fourth rotational speed sensor for detecting a fourth rotational speed information, and provides the fourth rotational speed information through a fourth rotational speed pin.

3. The fuel cell device with reserved signal pins according to claim 1, wherein the fuel cell device further comprises:
an air filter, which is configured between the first fan and the cathode fuel inlet, and is used to filter the air introduced by the first fan.

4. The fuel cell device with reserved signal pins according to claim 1, wherein the energy management system further comprises a charge battery, a charge circuit, in which the charge batter provides the power required in the initialization stage of the fuel cell device, and the charge circuit would charge the charge battery based on the power supplied by the transformer.

5. The fuel cell device with reserved signal pins according to claim 4, wherein the fuel cell device would change to be supplied with the power provided by the fuel cell pallets after completion of initialization stage of the fuel cell device.
